(19) United States
(12) Patent Application Publication
(10) Pub. No.: US 2022/0145223 A1
(43) Pub. Date: May 12, 2022

(54) Automatic Dishwashing Composition Comprising Metal Corrosion Inhibitors and Bleaches

(71) Applicant: Reckitt Benckiser Finish B.V., Hoofddorp (NL)

(72) Inventors: Alias Younis AL-BAYATI, Heidelberg (DE); Karlheinz Ulrich HAHN, Heidelberg (DE); Rainer MÜLLER-LEIFHEIT, Heidelberg (DE); Torsten ROTH, Heidelberg (DE); Ekrem SAHINER, Heidelberg (DE); Claudia SCHMAELZLE, Heidelberg (DE)

(73) Assignee: Reckitt Benckiser Finish B.V., Hoofddorp (NL)

(21) Appl. No.: 17/435,802

(22) PCT Filed: Mar. 6, 2020
(86) PCT No.: PCT/EP2020/056012

§ 371 Date: Sep. 2, 2021

(30) Foreign Application Priority Data
Mar. 11, 2019 (GB) 1903318.2

(51) Int. Cl. C11D 17/00; C11D 3/28; C11D 3/395

(52) U.S. Cl. CPC C11D 17/0091; C11D 3/3951; C11D 3/28

(57) ABSTRACT

An automatic dishwashing product comprising a bleaching agent and a compound in accordance with formula (1) or a salt or tautomer thereof, wherein A and B are independently selected from the group consisting of H, OR¹, and NHR², wherein R¹ and R² are independently selected from the group consisting of H and C₁-C₄ alkyl, with the proviso that A and B are not both H and are not both OH.

The present disclosure relates to an improved automatic dishwashing product. In particular, the present disclosure relates to the use of a silver/copper corrosion inhibitor in an automatic dishwashing product that is of comparable efficacy in inhibiting silver and copper corrosion to existing benzotriazole-based inhibitors while reducing the release of harmful and less biodegradable benzotriazoles into the environment.

A diverse array of compositions designed for use in automatic dishwasher machines is well known, and a consistent and ongoing effort has been made by detergent manufacturers to reduce the tarnishing of silver and copper items and surfaces in the dishwasher. This problem becomes apparent when bleach-containing compositions are employed, and especially those which contain oxygen-bleaching species. The level of tarnishing observed can range from slight discolouration to the formation of a dense black coating on the surface of the silverware or copperware, depending on the formulation and the bleaching agent. The dual challenge in formulating a product is therefore the optimization of the cleaning of bleachable soils while minimizing the occurrence of tarnishing of silverware items.

Existing formulations achieve this through the inclusion of BTA (1H-benzotriazole) and/or TTA (a mixture of 4-methyl-1H-benzotriazole and 5-methyl-1H-benzotriazole). BTA and TTA are both effective at reducing the tarnishing of silverware components in the presence of bleaching agents. However, BTA was found to be toxic to aquatic life and, in addition, is a potential endocrine disruptor (Seeland et al., J. Environ. Sci. Pollut. Res. Int, 2012, 19(5), 1781-1790.

While alternatives to BTA were initially identified, e.g. tellurium and selenium dioxide, they have been dismissed due concerns over toxicity. Moreover, reformulation efforts focusing on increased disilicate levels did not yield a viable formula with an improved anti-corrosion profile without exceeding regulatory limits. In the following years, BTA was exchanged by TTA in the formulations due to increasing indications of adverse effects of BTA. However, in recent years several studies have found that TTA (specifically the 4-methyl isomer) are harmful to the aquatic environment (see Brauch et. al., Water Research and Management, 2011, Vol. 1, No. 1, 17-28 and Huntscha et. al., J. Environ. Sci. Technol., 2014, 48, 4435-4443). Because TTA contains a significant quantity of the 4-methyl-1H-benzotriazole, existing bleach-containing automatic dishwashing compositions that are effective in minimising silver and copper tarnishing are also harmful to the aquatic environment.

It is one object of the present invention to provide alternative silver and/or copper corrosion inhibitors for bleach-containing automatic dishwashing products.

It is a further object of the present invention to provide alternative silver and/or copper corrosion inhibitors for bleach-containing automatic dishwashing products that are less harmful to the aquatic environment.

According to a first aspect, the present invention provides an automatic dishwashing product comprising a bleaching agent and a compound in accordance with formula (1) or a salt or tautomer thereof:

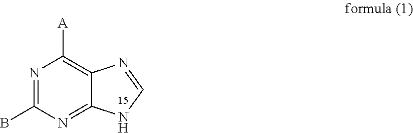

wherein A and B are independently selected from the group consisting of H, OR¹ and NHR², wherein R¹ and R² are independently selected from the group consisting of H and C₁-C₄ alkyl,
with the proviso that A and B are not both H and are not both OH.

The present inventors have found that these purine-based compounds, which comprise multiple potential donor sites capable of metal coordination, hydrogen bonding and/or crosslinking, display comparable silver and copper protection efficacy to commonly employed azoles (e.g. BTA and TTA). Since these compounds display a significantly more favourable biodegradation profile and/or are based on renewable resources, the ecological impact of the automatic dishwashing product is significantly reduced.

According to a second aspect, the present invention provides an automatic dishwashing product comprising a bleaching agent and a compound in accordance with formula (2) or a salt or tautomer thereof:

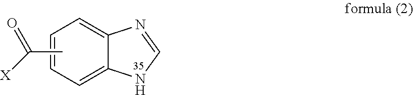

wherein X is OR³ or NHR³, wherein R³ is selected from the group consisting of H and C₁-C₄ alkyl.

Similarly to the purine-based compounds described above, the present inventors have found that these benzimidazole derivatives display a comparable silver and copper protection efficacy to BTA and TTA, while being more environmentally friendly.

According to a third aspect, the present invention provides a method of automatic dishwashing, the method comprising supplying a product to an automatic dishwasher and releasing the product or a portion thereof into a wash cycle of the automatic dishwasher, the product comprising a bleaching agent, and a compound having a structure in accordance with formula (1) or (2) or a salt or tautomer thereof.

According to a fourth aspect, the present invention provides a use of a compound according to formula (1) or (2) or a salt or tautomer thereof for reducing corrosion of silver and/or copper by a bleaching agent in an automatic dishwashing process.

The present invention will now be described further. In the following passages different aspects/embodiments of the invention are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

The present invention provides an automatic dishwashing product comprising a bleaching agent. The bleaching agent is preferably selected from the group consisting of an oxygen-releasing bleaching agent, a chlorine-releasing bleaching agent and mixtures of two or more thereof. More preferably, the bleaching agent is or comprises an oxygen-releasing bleaching agent. Oxygen-releasing bleaching agents are known to cause particularly pronounced silver and copper tarnishing, since the release of oxygen can lead to the formation of black silver and copper layers during the cleaning process (especially with low-alkaline formulations providing a pH of less than 11.5 at 1 wt % aqueous solution). Accordingly, the effect of the corrosion inhibitor is most pronounced in products comprising oxygen-releasing bleaching agents.

The bleaching agent may comprise the active bleach species itself or a precursor to that species. Preferably, the bleaching agent is selected from the group consisting of an inorganic peroxide, an organic peracid and mixtures of two or more thereof. The terms “inorganic peroxide” and “organic peracid” encompass salts and derivatives thereof. Inorganic peroxides include percarbonates, perborates, persulphates, hydrogen peroxide and derivatives and salts thereof. The sodium and potassium salts of these inorganic peroxides are suitable, especially the sodium salts. Most preferably, the bleaching agent is selected from the group consisting of sodium percarbonate, ε-phthalimido-peroxy-hexanoic acid (PAP), peracetic acid, potassium peroxymonosulfate (KMPS), and combinations of two or more thereof.

Preferably, the bleaching agent is present in an amount of from 1 to 50 wt % by weight of the automatic dishwashing product, more preferably from 2 to 30 wt %, and most preferably from 5 to 25 wt %. The term “by weight of the automatic dishwashing product”, as used herein, means based on the weight of the cleaning composition(s) and does not include any packaging or container such as any PVOH film, pouch or capsule housing the cleaning composition(s). All weight percentages expressed herein are by weight of the automatic dishwashing product unless otherwise specified.

The automatic dishwashing product may further comprise one or more bleach activators or bleach catalysts. Any suitable bleach activator may be included, for example TAED, if this is desired for the activation of the bleaching agent. Any suitable bleach catalyst may be used, for example manganese-based bleach catalysts and/or cobalt-based bleach catalysts. Exemplary manganese-based bleach catalysts include manganese acetate, manganese oxalate, or dinuclear manganese complexes such as those described in EP 1741774 A1, the contents of which are incorporated herein by reference. Exemplary cobalt-based bleach catalysts include cobalt complexes such as those described by the formula [Co(NH₃)₅M]T_{y}, wherein cobalt is in the +3 oxidation state, M is a carboxylate ligand and T is one or more counterions present in the number y, wherein y is an integer, preferably 1 or 2, to obtain a charge-balanced salt. Suitable cobalt complexes include those described in WO 1997/000311 A1 and U.S. Pat. No. 5,703,034 A, the contents of which are incorporated herein by reference. The organic peracids such as perbenzoic acid and peroxycarboxylic acids e.g. phthalimidoperoxyhexanoic acid (PAP) do not require the use of a bleach activator or catalyst as these bleaches are active at relatively low temperatures such as about 30° C.

In addition to the bleaching agent, the automatic dishwashing product comprises a compound in accordance with formula (1) or a salt or tautomer thereof:

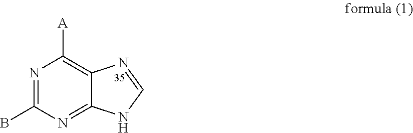

wherein A and B are independently selected from the group consisting of H, OR¹ and NHR², wherein R¹ and R² are independently selected from the group consisting of H and C₁-C₄ alkyl,
with the proviso that A and B are not both H and are not both OH.

By “tautomer” it is meant a structural isomer resulting from the migration of a proton from one atom of the compound to another, for example the keto-enol tautomerism of guanine (where A is NH₂ and B is OH).

Preferably, A and B are independently selected from H, OR¹ and NHR², wherein R¹ and R² are independently selected from the group consisting of H and methyl, more preferably wherein R¹ and R² are H.

Preferably A is OH and B is NHR², wherein R² is selected from the group consisting of H and methyl. Alternatively, A is NHR² and B is OH, wherein R² is selected from the group consisting of H and methyl.

In an especially preferred embodiment, A is OH and B is NH₂. In a further especially preferred embodiment, A is NH₂ and B is OH (i.e. the compound is guanine).

According to a second aspect, there is provided an automatic dishwashing product comprising a bleaching agent and a compound in accordance with formula (2) or a salt or tautomer thereof:

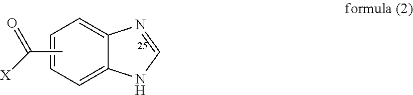

wherein X is OR³ or NHR³, wherein R³ is selected from the group consisting of H and C₁-C₄ alkyl.

Preferably, X is OR³ or NHR³, wherein R³ is selected from the group consisting of H and methyl.

Preferably, X is OH or NH₂. Most preferably, X is OH.

In an especially preferred embodiment, the compound in accordance with formula (2) is

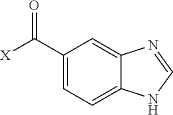

or a salt or a tautomer thereof. Preferably X is as defined above.

As explained above, the present inventors have found that compounds according to formula (1) or formula (2) are effective silver and/or copper corrosion inhibitors in bleach-containing automatic dishwashing products, while being more environmentally friendly than the widely used azoles (BTA and TTA).

Preferably, the compound according to formula (1) or formula (2), or salt or tautomer thereof, is present in an amount of from 0.01 to 1 wt % by weight of the automatic dishwashing product, more preferably from 0.01 to 0.5 wt %. It is to be understood that the weight of a salt form is taken to include the weight of the counterion(s).

Preferably, the bleaching agent and the compound according to formula (1) or formula (2), or salt or tautomer thereof, are present in a weight ratio of from 20:1 to 500:1, more preferably from 20:1 to 200:1, still more preferably from 50:1 to 150:1. It is to be understood that this defines the weight ratio of the bleaching agent to the compound according to formula (1) or (2) (or salt or tautomer thereof).

Preferably, the product has a pH of less than 11.5 at 1 wt % aqueous solution at 20° C., more preferably from 7 to 10.5. In other words, the product preferably has a pH within these ranges when diluted in water in an amount of 1 wt % based on the weight of the aqueous solution that forms. For this definition, the term “product” refers to the cleaning composition(s) and does not include any packaging or container such as any PVOH film, pouch or capsule housing the cleaning composition(s). Preferably, the product is formulated to provide, in use, a cleaning solution having a pH of less than 11.5 at a wash cycle temperature of from 30 to 65° C., more preferably from 7 to 10.5. In other words, the product is preferably a “low-alkaline” formulation. Low-alkaline formulations containing bleaching agents, especially oxygen-releasing bleaching agents, are known to be particularly corrosive towards silver and copper. This is because the relatively low pH further shifts the oxidation potentials to favour the formation of black silver and copper layers during the cleaning process. Accordingly, the corrosion inhibitor of the present invention is particularly effective in low-alkaline formulations.

The automatic dishwashing product may comprise a source of acidity or a source of alkalinity, to obtain or/and buffer the desired pH on dissolution. The source of acidity may be any suitable acidic compound, for example a polycarboxylic acid. The source of alkalinity may, for example, be a carbonate or bicarbonate (such as the alkali metal or alkaline earth metal salts). The source of alkalinity may suitably be any suitable basic compound for example any salt of a strong base and a weak acid. When an alkaline composition is desired silicates are amongst the suitable sources of alkalinity. Preferred silicates are sodium silicates such as sodium disilicate, sodium metasilicate and crystalline phyllosilicates. In an embodiment, the product is free of silicates.

Preferably, the automatic dishwashing product further comprises:
one or more builders, and/or
one or more surfactants, and/or
one or more enzymes.

The automatic dishwashing product is preferably an automatic dishwashing detergent product.

Builders

The automatic dishwashing product may comprise a builder (or co-builder). The builder/co-builder may be either a phosphorous-containing builder or a phosphorous-free builder as desired. In many jurisdictions, phosphate builders are banned. Preferably, therefore, the automatic dishwashing product is phosphate-free.

If phosphorous-containing builders are to be used, it is preferred that mono-phosphates, di-phosphates, tri-polyphosphates or oligomeric-polyphosphates are used. The alkali metal salts of these compounds are preferred, in particular the sodium salts. An especially preferred builder is sodium tripolyphosphate (STPP). Conventional amounts of the phosphorous-containing builders may be used typically in the range of from 15 to 60 wt % by weight of the automatic dishwashing product, such as from 20 to 50 wt % or from 25 to 40 wt %.

If phosphorous-free builder is included, it preferably comprises an aminocarboxylate or a citrate. Most preferably, the builder is selected from the group consisting of methylglycine diacetic acid (MGDA), N,N-dicarboxymethyl glutamic acid (GLDA), citrate and combinations of two or more thereof. It is to be appreciated that the terms MGDA, GLDA and citrate encompass the free acids as well as salts, esters and derivatives thereof. Preferably, the citrate is trisodium citrate.

Other phosphorous-free builders include succinate based compounds. The terms “succinate based compound” and “succinic acid based compound” are used interchangeably herein. Conventional amounts of the succinate based compounds may be used, typically in the range of from 5 to 80 wt % by weight of the automatic dishwashing product, such as from 15 to 70 wt % or from 20 to 60 wt %. The compounds may be used individually or as a mixture.

Other suitable builders are described in U.S. Pat. No. 6,426,229, which is incorporated by reference herein. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), a-alanine-N,N-diacetic acid (a-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N, N-diacetic acid (TUDA) and sulfomethyl-N,N-diacetic acid (SM DA) and alkali metal salts or ammonium salts thereof.

Further preferred succinate compounds are described in U.S. Pat. No. 5,977,053, which is incorporated herein by reference, and have the formula:

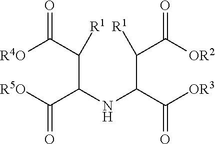

in which R, R¹, independently of one another, denote H or OH; R², R³, R⁴, R⁵, independently of one another, denote a cation, hydrogen, alkali metal ions and ammonium ions, ammonium ions having the general formula R⁶R⁷R⁸R⁹N⁺ and R⁶, R⁷, R⁸, R⁹, independently of one another, denote hydrogen, alkyl radicals having 1 to 12 C atoms or hydroxyl-substituted alkyl radicals having 2 to 3 C atoms.

Preferred examples include tetrasodium imminosuccinate. Iminodisuccinic acid (IDS) and (hydroxy)iminodisuccinic acid (HIDS) and alkali metal salts or ammonium salts thereof are especially preferred succinate based builder salts. The phosphorous-free co-builder may also or alternatively comprise non-polymeric organic molecules with carboxylic group(s). Builder compounds which are organic molecules containing carboxylic groups include citric acid, fumaric acid, tartaric acid, maleic acid, lactic acid and salts thereof. In particular the alkali or alkaline earth metal salts of these organic compounds may be used, and especially the sodium salts. An especially preferred phosphorous-free builder is sodium citrate. Such polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Such polycarboxylates which contain three carboxyl groups include, for example, water-soluble citrate. Correspondingly, a suitable hydroxycarboxylic acid is, for example, citric acid.

Preferred secondary builders include homopolymers and copolymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts. Secondary builders which are organic are preferred. A polymeric polycarboxylic acid is the homopolymer of acrylic acid. Other suitable secondary builders include polyepoxysuccinic acids (PESAs). Other suitable secondary builders are disclosed in WO 95/01416, to the contents of which express reference is hereby made. Most preferably, the secondary builder is trisodium citrate.

Preferably the total amount of builder present in the automatic dishwashing product is at least 20 wt % by weight of the automatic dishwashing product, and most preferably at least 25 wt %, preferably in an amount of up to 70 wt %, preferably up 60 wt %, more preferably up to 45 wt %. The actual amount used in the product will depend upon the nature of the builder used. If desired a combination of phosphorous-containing and phosphorous-free builders may be used.

In an especially preferred embodiment, the automatic dishwashing product is phosphate-free and comprises (i) an aminocarboxylate selected from the group consisting of MGDA, GLDA and a combination thereof, and (ii) trisodium citrate, wherein the aminocarboxylate and the trisodium citrate are present in an amount of from 10 to 60 wt % by weight of the automatic dishwashing product.

Surfactants

Surfactants may also be included in the automatic dishwashing product and any of nonionic, anionic, cationic, amphoteric or zwitterionic surface active agents or suitable mixtures thereof may be used. Many such suitable surfactants are described in Kirk Othmer's Encyclopedia of Chemical Technology, 3rd Ed., Vol. 22, pp. 360-379, “Surfactants and Detersive Systems”, incorporated by reference herein. In general, bleach-stable surfactants are preferred according to the present invention.

In the case of automatic dishwashing products, it is preferred to minimise the amount of anionic surfactant. Preferably the product comprises no more than 2 wt %, no more than 1 wt %, or no, anionic surfactant. Preferably the product comprises no more than 5 wt %, no more than 1 wt %, or no, ionic surfactant of any type. Non-ionic surfactants are especially preferred instead for automatic dishwashing products.

A preferred class of non-ionic surfactants is ethoxylated non-ionic surfactants prepared by the reaction of a monohydroxy alkanol or alkylphenol with 6 to 20 carbon atoms. Preferably the surfactants have at least 12 moles, particularly preferred at least 16 moles, and still more preferred at least 20 moles, such as at least 25 moles, of ethylene oxide per mole of alcohol or alkylphenol. Particularly preferred non-ionic surfactants are the non-ionics from a linear chain fatty alcohol with 16-20 carbon atoms and at least 12 moles, particularly preferred at least 16 and still more preferred at least 20 moles, of ethylene oxide per mole of alcohol.

According to one embodiment of the invention, the non-ionic surfactants additionally may comprise propylene oxide units in the molecule. Preferably these PO units constitute up to 25 wt %, preferably up to 20 wt %, and still more preferably up to 15 wt % by weight of the overall molecular weight of the non-ionic surfactant.

Surfactants which are ethoxylated mono-hydroxy alkanols or alkylphenols, which additionally comprises polyoxyethylene-polyoxypropylene block copolymer units may be used. The alcohol or alkylphenol portion of such surfactants constitutes more than 30 wt %, preferably more than 50 wt %, more preferably more than 70 wt % by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane.

Another preferred class of nonionic surfactant can be described by the formula:

R₁O[CH₂CH(CH₃)O]ₓ[CH₂CH₂O]_{y}[CH₂CH(OH)R₂]

where R₁ represents a linear or branched chain aliphatic hydrocarbon group with 4-18 carbon atoms or mixtures thereof, R₂ represents a linear or branched chain aliphatic hydrocarbon rest with 2-26 carbon atoms or mixtures thereof, x is a value between 0.5 and 1.5, and y is a value of at least 15.

Another group of preferred non-ionic surfactants are the end-capped polyoxyalkylated non-ionics of formula:

R₁O[CH₂CH(R₃)O]ₓ[CH₂]ₖCH(OH)[CH₂]ⱼOR₂

where R₁ and R₂ represent linear or branched chain, saturated or unsaturated, aliphatic or aromatic hydrocarbon groups with 1-30 carbon atoms, R₃ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R₃ in the formula above can be different. R₁ and R₂ are preferably linear or branched chain, saturated or unsaturated, aliphatic or aromatic hydrocarbon groups with 6-22 carbon atoms, where groups with 8 to 18 carbon atoms are particularly preferred. For the group R₃, H, methyl or ethyl is particularly preferred. Particularly preferred values for x are comprised between 1 and 20, preferably between 6 and 15.

As described above, in case x>2, each R₃ in the formula can be different. For instance, when x=3, the group R₃ could be chosen to build ethylene oxide (R₃═H) or propylene oxide (R₃=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise. Particularly preferred end-capped polyoxyalkylated alcohols of the above formula are those where k=1 and j=1 originating molecules of simplified formula:

R₁O[CH₂CH(R₃)O]ₓCH₂CH(OH)CH₂OR₂

Another group of preferred non-ionic surfactants are mixed alkoxylate fatty alcohol nonionic surfactants

The standard non-ionic surfactant structure is based on a fatty alcohol with a carbon C8 to C20 chain, wherein the fatty alcohol has been ethoxylated or propoxylated. The degree of ethoxylation is described by the number of ethylene oxide units (EO), and the degree of propoxylation is described by the number of propylene oxide units (PO). Such surfactants may also comprise butylene oxide units (BO) as a result of butoxylation of the fatty alcohol. Preferably, this will be a mix with PO and EO units. The surfactant chain can be terminated with a butyl (Bu) moiety.

Preferably the mixed alkoxylate fatty alcohol non-ionic surfactants comprise between 3 to 5 moles of the higher alkoxylate group and between 6 to 10 moles the higher lower group. Especially preferred are mixed alkoxylate fatty alcohol nonionic surfactants having 4 or 5 moles of the higher alkoxylate group and 7 or 8 moles of the lower alkoxylate group. According to one aspect of the invention a mixed alkoxylate fatty alcohol nonionic surfactant having 4 or 5 PO moles and 7 or 8 EO moles is especially preferred and good results have been obtained with for surfactants with 4 PO moles and 8 EO moles. In an especially preferred embodiment the mixed alkoxylate fatty alcohol nonionic surfactant is C12-15 8EO/4PO (commercially available as Genapol EP 2584 ex Clariant, Germany).

The use of mixtures of different non-ionic surfactants is suitable in the context of the present invention, for instance mixtures of alkoxylated alcohols and hydroxy group containing alkoxylated alcohols.

Other suitable surfactants are disclosed in WO 95/01416, which is incorporated herein by reference.

Preferably the non-ionic surfactants are present in the automatic dishwashing product in an amount of from 0.1 to 20 wt % by weight of the automatic dishwashing product, more preferably from 1 to 15 wt %, such as from 2 to 10 wt %.

Enzymes

The automatic dishwashing product may include one or more enzymes. It is preferred that the one or more enzymes are selected from proteases, lipases, amylases, cellulases and peroxidases, with proteases and amylases being most preferred. It is most preferred that protease and/or amylase enzymes are included in the products according to the invention as such enzymes are especially effective in dishwashing detergent compositions. Any suitable species of these enzymes may be used as desired. More than one species may be used.

Additional Components

The skilled person will be aware of the kinds of ingredients that may be present in ADW (automatic dishwashing) products. The automatic dishwashing product of the present invention may comprise any other suitable ingredients known in the art.

For example, polymers intended to improve the cleaning performance of the automatic dishwashing product may also be included therein. For example sulphonated polymers may be used. Preferred examples include copolymers of CH₂═CR¹CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2 propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof. Suitable sulphonated polymers are also described in U.S. Pat. No. 5,308,532 and in WO 2005/090541, which are incorporated herein by reference.

When a sulfonated polymer is present, it is preferably present in an amount of at least 0.1 wt % by weight of the automatic dishwashing product, preferably at least 0.5 wt %, more preferably at least 1 wt %, and most preferably at least 3 wt %, up to 40 wt %, preferably up to 25 wt %, more preferably up to 15 wt %, and most preferably up to 10 wt %.

The automatic dishwashing product may also comprise one or more foam control agents. Suitable foam control agents for this purpose are all those conventionally used in this field, such as, for example, silicones and their derivatives and paraffin oil. The foam control agents are preferably present in amounts of 0.5 wt % or less.

The automatic dishwashing product may also comprise minor, conventional, amounts of preservatives, fragrances, and the like.

Product Format

The product may be in the form of a tablet, a powder, granules, a liquid, a gel, a paste, or combinations of two or more thereof.

The product may comprise a single composition or a plurality of compositions. For example, the product may comprise a single composition comprising the bleaching agent and the compound according to formula (1) or (2), the single composition preferably being in the form of a tablet, a powder, granules, a liquid, a gel or a paste.

In embodiments where the product comprises a plurality of compositions, the bleaching agent and the compound according to formula (1) or (2) may each be provided in different compositions. Alternatively, the bleaching agent and the compound according to formula (1) or (2) may be present in the same composition.

Preferably, the product is in a unit dose or monodose form. In other words, the product comprises one or more compositions in the quantity required for a single wash cycle. The terms monodose and unit dose are used interchangeably throughout this disclosure.

The monodose product may comprise a tablet with a gel portion or layer. In these embodiments the bleaching agent and compound according to formula (1) or (2) may be provided in the tablet and/or the gel portion or layer. If compressed tablets form a portion of the automatic dishwashing product, they may be homogeneous or composed of multi-layers. If the tablets are multi-layered then different layers may comprise different parts of the detergent. This may be done to increase stability or increase performance, or both.

In an embodiment, the automatic dishwashing product is housed within a water soluble film or container, preferably a polyvinylalcohol film or container. The film or container may be a PVOH rigid capsule or film blister. The PVOH capsule or blister may have a single compartment or may be multi-compartment. Multi-compartment blisters or capsules may have different portions of the product in each compartment, or the same composition in each compartment. The distinct regions/compartments may contain any proportion of the total amount of ingredients as desired. The PVOH capsules or film blisters may be filled with tablets, powders, gels, pastes or liquids, or combinations of these, within the scope of the invention. These PVOH capsules or blisters may have a single compartment or may be multi-compartment. Multi-compartment blisters or capsules may have different portions of the product in each compartment, or the same composition in each compartment. Each compartment may contain any proportion of the total amount of ingredients as desired. Each compartment may comprise the compound according to formula (1) or (2), and/or the bleaching agent, and/or one or more builders, and/or one or more surfactants, and/or one or more enzymes. The PVOH capsules or film blisters may be filled with tablets, powders, granules, liquids, gels, pastes, or combinations of two or more thereof.

The film or container may be an injection moulded PVOH capsule with multiple compartments. Each compartment may comprise a different composition. Optionally, one or more of the compartments may contain a gel or liquid composition. Each compartment may comprise the compound according to formula (1) or (2), and/or the bleaching agent, and/or one or more builders, and/or one or more surfactants, and/or one or more enzymes. Each compartment may be filled with a tablet, a powder, granules, a liquid, a gel, a paste, or combinations of two or more thereof.

According to a third aspect, the present invention provides a method of automatic dishwashing, the method comprising supplying a product to an automatic dishwasher and releasing the product or a portion thereof into a wash cycle of the automatic dishwasher, the product comprising a bleaching agent, and a compound having a structure in accordance with formula (1) or (2) or a salt or tautomer thereof.

Preferably, the product is the product of the first or second aspects.

Preferably, the dishwasher contains silverware and/or copperware. The terms “silverware” and “copperware” as used herein refer to articles formed of or coated with silver and copper respectively. It is to be understood that the terms silver and copper encompass the elements themselves and alloys containing the elements. As explained above, the corrosion inhibitor of the present invention is effective in inhibiting the corrosion of copper and silver. It is to be understood that the silverware and/or copperware are present in the dishwasher during the wash cycle of the method.

Preferably, the product is formulated to provide, in use, a cleaning solution having a pH of less than 11.5 at a wash cycle temperature of from 30 to 65° C., more preferably from 7 to 10.5. That is, the step of releasing the product into the dishwasher preferably comprises dissolving and/or dispersing the product or a portion thereof in water at a temperature of from 40 to 60° C. to form a cleaning solution having a pH of less than 11.5, or from 7 to 10.5, and contacting soiled articles (such as silverware and copperware) with the cleaning solution. In other words, the product is preferably a “low-alkaline” formulation, as discussed above.

In the step of releasing the product or a portion thereof into a wash cycle of the automatic dishwasher, from 0.1 to 6.5 grams of bleaching agent and/or from 1 to 500 milligrams of the compound according to formula (1) or (2) are preferably released into the wash cycle, more preferably from 1 to 4 grams of bleaching agent and from 1 to 100 milligrams of the compound according to formula (1) or (2).

According to a fourth aspect, the present invention provides a use of a compound according to formula (1) or (2) or a salt or tautomer thereof for reducing corrosion of silver and/or copper by a bleaching agent in an automatic dishwashing process.

Preferably, the bleaching agent is an oxygen-releasing bleaching agent.

Preferably, the use of the fourth aspect comprises the use of the product of the first or second aspects, optionally in the process of the third aspect.

All percentages used in this disclosure are by weight unless otherwise specified.

The present invention will now be described in relation to the following non-limiting examples.

### EXAMPLE 1

In order to evaluate the feasibility of the compounds listed below for use in ADW detergents, a base powder formulation without any silver/copper corrosion inhibitors was prepared and tested. To this formulation were added either 27 mg of a TTA powder mix as benchmark level of silver protection or a comparable amount of the test candidates.

General Methods

Silver corrosion experiments were conducted using the condition and evaluation scheme outlined below:

Test method: Material Care G404 V18 EU
Machine: modified Miele G 1222 SC GSL

### Program: 65° C./65° C.

Water hardness: 21° dH
Rinse Aid: without rinse aid
Evaluators: 2 trained people

Scores:

5=no discolouration/shine loss
4=minor discolouration/shine loss
3=discolouration/shine loss visible
2=strong discolouration/shine loss
1=very strong discolouration/shine loss

All compounds used in the following experiments were obtained from commercial suppliers:

### TTA (CAS No. 29385-43-1, Italmatch)

Indole-6-carboxylic acid (CAS No. 1670-82-2, Alfa Aesar)

### Benzimidazole (CAS No. 51-17-2, Sigma Aldrich)

5-Benzimidazolecarboxylic acid (CAS No. 15788-16-6, Sigma Aldrich)

### Allantoin (CAS No. 97-59-6, Sigma Aldrich)

### Guanine (CAS No. 73-40-5, Sigma Aldrich)

Uric acid (CAS No. 69-93-2, Alfa Aesar)

### Cytosine (CAS No. 71-30-7, Alfa Aesar)

### Xanthine (CAS No. 69-89-6, Alfa Aesar)

Phytic acid sodium salt hydrate (CAS No. 14306-25-3, Sigma Aldrich)
Folic acid (CAS No. 59-30-3, Sigma Aldrich)

The benchmark formulation of base powder for Examples 1 and 2 is shown below:

| Raw Material | g/dose |
|---|---|
| Bleach system (Sodium | 3.0 |
| Percarbonate, TAED, manganese bleach | |
| catalyst) | |
| Builders | 7.5 |
| Surfactants/polymers | 1.7 |
| Sodium Carbonate/bicarbonate | 7.5 |
| Enzymes | 0.1 |
| Others (Antifoam, Fragrances, Dyes, etc.) | rest |
| TOTAL | 20.00 |

The averaged results are shown in the table below:

| | | | | 20 g | 20 g base | | |
|---|---|---|---|---|---|---|---|
| | | | | base | powder + | | |
| | | | | powder | 0.027 g | 20 g base | 20 base powder + |
| | | | 20 g | + | indole-6- | powder + | 0.027 g 5- |
| | | | base | 0.027 g | carboxylic | 0.027 g | benzimidazole- |
| Test product: | | | powder | TTA | acid | benzimidazole | carboxylic acid |
| Silver | 21° dH | 25 | 1.0 | 3.1 | 1.2 | 1.1 | 2.3 |
| tarnishing | water | cycles | | | | | |
| | | 0 | 5.0 | 5.0 | 5.0 | 5.0 | 5.0 |
| | | cycles | | | | | |

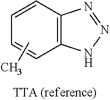

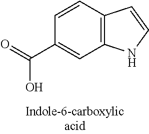 [SMILES: O=C(O)c1ccc2cc[nH]c2c1]

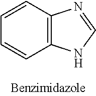

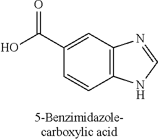 [SMILES: O=C(O)c1ccc2[nH]cnc2c1]

Whereas Indole-6-carboxylic acid and Benzimidazole both offer only two functional groups for molecular cross-linking and/or metal coordination (in addition to the n-electron system common to all of them), TTA and 5-Benzimidazole-carboxylic acid contain three distinct sites each capable of hydrogen bonding, metal coordination and/or crosslinking.

In conclusion, Example 1 shows that aromatic compounds for silver surface protection require at least three binding sites in their structure.

### EXAMPLE 2

A selection of nitrogen-rich compounds each comprising an aromatic pi-electron system and several binding sites were evaluated, as well as natural products comprising multiple binding sites (e.g. carboxylic acids, phosphonic acid), using the method and base powder of Example 1. The results are shown in the table below.

| | | | | | | 20 g base | |
|---|---|---|---|---|---|---|---|
| | | | | 20 g base | 20 g base | powder + | 20 base |
| | | | 20 g | powder + | powder + | 0.027 g | powder + |
| | | | base | 0.027 g | 0.027 g | phytic acid, | 0.027 g |
| Test product: | | | powder | TTA | folic acid | Na-salt | guanine |
| Silver | 21° dH | 25 | 1.0 | 3.1 | 1.2 | 1.1 | 2.3 |
| tarnishing | water | cycles | | | | | |
| | | 0 | 5.0 | 5.0 | 5.0 | 5.0 | 5.0 |
| | | cycles | | | | | |

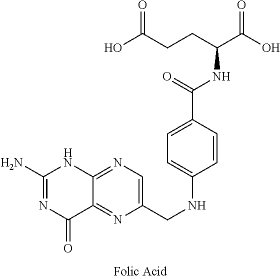 [SMILES: Nc1nc(=O)c2nc(CNc3ccc(C(=O)N[C@@H](CCC(=O)O)C(=O)O)cc3)cnc2[nH]1]

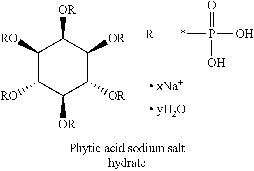

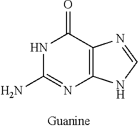 [SMILES: Nc1nc2[nH]cnc2c(=O)[nH]1]

While all of these compounds—folic acid, phytic acid sodium salt, and guanine—showed a general improvement of the silver corrosion protection versus the Base Powder, only guanine achieved a comparable performance to TTA.

### EXAMPLE 3

Heterocycles structurally related to guanine were evaluated using the method and base powder of Example 1. The results are shown in the table below.

| | | | | 20 g base | 20 g base | 20 g base | 20 base |
|---|---|---|---|---|---|---|---|
| | | | 20 g | powder + | powder + | powder + | powder + |
| | | | base | 0.027 g | 0.027 g | 0.027 g | 0.027 g |
| Test product: | | | powder | xanthine | uric acid | allantoin | cytosine |
| Silver | 21° dH | 25 | 1.0 | 1.0 | 1.0 | 1.0 | 1.0 |
| tarnishing | water | cycles | | | | | |
| | | 0 | 5.0 | 5.0 | 5.0 | 5.0 | 5.0 |
| | | cycles | | | | | |

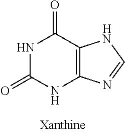 [SMILES: O=c1[nH]c(=O)c2[nH]cnc2[nH]1]

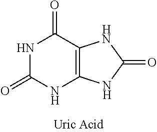 [SMILES: O=c1[nH]c(=O)c2[nH]c(=O)[nH]c2[nH]1]

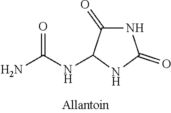 [SMILES: NC(=O)NC1NC(=O)NC1=O]

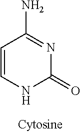

It was found that none of the tested materials—xanthine, uric acid, allantoin or cytosine—showed an impact on the corrosion protection profile, despite their close structural relationship to guanine. Without wishing to be bound by theory, it is believed that a balance between Lewis-basic and Lewis-acidic functional groups is required for silver/copper corrosion protection efficacy.

### EXAMPLE 4

Guanine was tested as a silver protecting agent in the following base formulation:

| Raw Material | g/dose |
|---|---|
| Bleach system (Sodium Percarbonate, | 3.1 |
| TAED, etc.) | |
| Builders | 6.7 |
| Surfactants/polymers | 2.8 |
| Alkali (Sodium Carbonate/bicarbonate) | 2.1 |
| Enzymes | 0.1 |
| Binders & Distintegrants | 1.6 |
| Others (dyes, antifoam, processing aids, | rest |
| fragrances) | |
| TOTAL | 16.9 |

Using similar test conditions as in the previous experiments, the base formulation resulted in the formation of a strong black layer on the silver cutlery after only ten wash cycles, which would be unacceptable for use in a consumer household. In comparison, the inventive composition comprising the base formulation and 25 mg guanine resulted in significantly less shine loss and discolouration. Moreover, while the formulations showed a comparable surface deterioration after one wash cycle, guanine enabled corrosion protection over multiple cycles.

The results are shown in the table below.

| | | | 16.9 g base | 16.9 g base formulation + |
|---|---|---|---|---|
| Test product: | | | formulation | 25 mg guanine |
| Silver | 21° dH | 10 | 1.0 | 2.6 |
| tarnishing | water | cycles | | |
| | | 0 cycles | 5.0 | 5.0 |

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. An automatic dishwashing product comprising:
a bleaching agent, and
a compound in accordance with formula (1) or a salt or tautomer thereof: 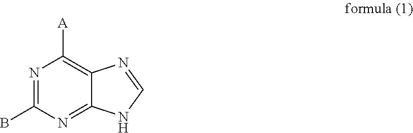
wherein A and B are independently selected from the group consisting of H, OR¹ and NHR², wherein R¹ and R² are independently selected from the group consisting of H and C₁-C₄ alkyl,
wherein A and B are not both H and are not both OH.

2. The automatic dishwashing product according to claim 1, wherein A is OH and B is NH₂, or wherein A is NH₂ and B is OH.

3. An automatic dishwashing product comprising:
a bleaching agent, and
a compound in accordance with formula (2) or a salt or tautomer thereof: 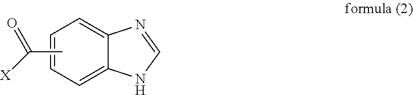
wherein X is OR³ or NHR³, wherein R³ is selected from the group consisting of H and C₁-C₄ alkyl.

4. The automatic dishwashing product according to claim 3, wherein the compound in accordance with formula (2) is 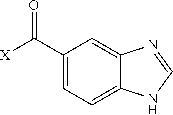
or a salt or tautomer thereof.

5. The automatic dishwashing product according to claim 3, wherein X is OH.

6. The automatic dishwashing product according to claim 1, wherein the bleaching agent and the compound in accordance with formula (1), or salt or tautomer thereof, are present in a weight ratio of from 20:1 to 500:1.

7. The automatic dishwashing product according to claim 1, wherein the bleaching agent is an oxygen-releasing bleaching agent.

8. The automatic dishwashing product according to claim 1, wherein the product has a pH of less than 11.5 at 1 wt % aqueous solution at 20° C.

9. The automatic dishwashing product according to claim 1, the automatic dishwashing product further comprising:
one or more builders, and/or
one or more surfactants, and/or
one or more enzymes.

10. The automatic dishwashing product according to claim 1, wherein the product is:
in a unit dose form; and/or
housed within a water soluble or water dispersible film or container, preferably a polyvinyl alcohol film or container.

11. A method of automatic dishwashing, the method comprising:
supplying a product to an automatic dishwasher; and
releasing the product or a portion thereof into a wash cycle of the automatic dishwasher, the product comprising a bleaching agent, and a compound having a structure in accordance with formula (1) or (2) or a salt or tautomer thereof.

12. The method according to claim 11, wherein the automatic dishwasher contains silverware and/or copperware.

13. The method according to claim 11, wherein the product is formulated to provide, in use, a cleaning solution having a pH of less than 11.5 at a wash cycle temperature of from 30 to 65° C.

14. The method according to claim 1, wherein in the step of releasing the product or a portion thereof into a wash cycle of the automatic dishwasher, from 0.1 to 6.5 grams of bleaching agent and/or from 1 to 500 milligrams of the compound according to formula (1) or (2) are released into the wash cycle.

15. A method of using a compound according to formula (1) or (2) or a salt or tautomer thereof for reducing corrosion of silver and/or copper by a bleaching agent in an automatic dishwashing process.

16. The automatic dishwashing product according to claim 3, wherein the bleaching agent and the compound in accordance with formula (2), or salt or tautomer thereof, are present in a weight ratio of from 20:1 to 500:1.

17. The automatic dishwashing product according to claim 3, wherein the bleaching agent is an oxygen-releasing bleaching agent.

18. The automatic dishwashing product according to claim 3, wherein the product has a pH of less than 11.5 at 1 wt % aqueous solution at 20° C.

19. The automatic dishwashing product according to claim 3, the automatic dishwashing product further comprising:
one or more builders, and/or
one or more surfactants, and/or
one or more enzymes.

20. The automatic dishwashing product according to claim 3, wherein the product is:
in a unit dose form; and/or
housed within a water soluble or water dispersible film or container, preferably a polyvinyl alcohol film or container.
